(19) United States
(12) Patent Application Publication
(10) Pub. No.: US 2012/0315616 A1
(43) Pub. Date: Dec. 13, 2012

(54) E-LEARNING METHOD AND SYSTEM

(75) Inventor: Mark Fourman, Somerville, MA (US)

(73) Assignee: THE LEARNING CONTAGION, LLC., Somerville, MA (US)

(21) Appl. No.: 13/159,265

(22) Filed: Jun. 13, 2011

(51) Int. Cl. G09B 3/00

(52) U.S. Cl. 434/350

(57) ABSTRACT

A system for delivering e-learning in ways that support many of the teaching and learning practices of interactive classroom training through electronic interactions. In a first aspect, an embodiment provides Dynamic Learning Groups, i.e., peer groups of students who will have social learning interactions as they go through a course. These groups can be used to provide fine-grained access control to student-generated content. In a second aspect, an embodiment provides Dynamic Mentor Groups which enable mentoring (i.e., “teaching”) interactions between students and defined sets of mentors or teachers. In a third aspect, an embodiment provides Structured Notes Management which allows users to make notes in situ as they go through a course, and have those notes presented back to them in structured forms that summarize their notes in a graphical presentation that both captures their notes and reinforces the key learnings of the course.

### FIELD

The subject matter disclosed herein relates, generally, to a system for delivering e-learning in ways that support many of the teaching and learning practices of interactive classroom training through electronic interactions.

### BACKGROUND

E-learning is a general term for all forms of electronically supported transfer of skills and knowledge. E-learning uses computers and networks, in particular the Internet, to deliver content to students and to allow students to interact with each other and with their teachers.

Software to support e-learning is available under various names. Some popular terms of art are Course Management Systems (CMS), Learning Management Systems (LMS) and Virtual Learning Environments (VLE). Such systems provide software applications for the administration, documentation, management, tracking, and reporting of training programs, classroom and online events, e-learning programs, and training content. Typically such systems are made available over the world-wide web as an online service, although other arrangements (e.g., a locally hosted solution) are also possible.

Two well-known examples of such systems are the open-source Moodle™ software package and the Blackboard Learning System (BLS) developed and marketed by Blackboard Inc. The BLS allows students to enroll in various electronic courses. Each course includes several pages, for example including reading material, videos, hyperlinks to external sources, quizzes and tests and downloadable material. An electronic forum is provided with each course allowing students to freely discuss any aspect of a course, or any other topic they feel like, with each other. Teachers can use the forum to provide feedback or engage in discussions. Students further can be subdivided into groups, allowing closer interaction between groups and the sharing of information that is restricted to members of a group. Moodle™ provides a similar groups feature that allows administrators to assign teachers and students to one or more groups. This can be on the course or on the activity level.

However, current e-learning systems suffer from various disadvantages. Such systems are focused on delivering the educational content, with social interaction provided as an afterthought. Typically, existing systems have one or more forums or message boards where students and teachers interact. However, these social interactions are separated from the course content. In web-based systems, course content is delivered in one area of the website while social interaction is supported in another area of the website. By analogy, this would be like having a school where teachers delivered presentations in one room, but then teachers and students had to go to another room to have any conversations about the materials taught.

In Moodle™ there is support for groupings of students, for example a course teacher (i.e., administrator) can assign students to groups on the course or activity level. However, once students are assigned to these groups, the social interaction between students still occurs in ways that are separated from the learning content. Continuing with the analogy above, this would be similar to sending students to separate rooms for discussion of course content after they had listened to the one-way delivery of presentations. Moreover, the groupings defined by teachers and administrators are fixed, and cannot be changed by users. By analogy, this would be equivalent to preventing students form having any “out of class” conversations with groups they choose, and preventing students from choosing to share certain information with peer groups of their own choosing. This is contrary to the social interactions that are important to live training programs, where students choose to share certain information only with certain people, and have conversations with organically-formed sub-groups around the coffee maker or water cooler.

Some current e-learning systems provide tools for students to navigate through their courses. In these systems the user navigation functions are limited to showing users what course modules they have access to (i.e., the courses they're enrolled in) and the forums or chat rooms they have access to. Thus, current systems are consistent with the mindset of having social interactions separated from courseware. Moreover, the current systems generally define navigation structures presented to users on the basis of a predetermined navigation path. These systems do not provide students with adequate tools for tracking their progress through courses, tracking their work product as they go through courses, or including social interactions in their tracking of their course progress and work product.

Most current e-learning systems provide facilities for students to post comments online. However, these comments are limited to simple notes (including formatted text and sometimes HTML code), typically posted in a forum separate from the learning content Current e-learning systems do not provide facilities for managing structured notes online as one might do in a live course by filling out a structured worksheet.

Accordingly, there is a need for an improved e-learning system that integrates educational and social aspects of e-learning.

### SUMMARY

In a first aspect, an embodiment provides a computer-implemented system for supporting electronic learning over a network to plural students, comprising course provision means for the plural students to access courseware in the form of one or more course pages individually accessible over the network, comment presenting means for inserting comments into each course page, said comments having been previously posted by students accessing that course page, allowing students accessing that course page to view the posted comments as an integral part of the course page, commenting means for allowing a particular of the plural students to post one or more further comments for that course page, which one or more further comments then are inserted into the course page by the comment viewing means, and limiting means for allowing the particular student to limit visibility of any particular comment posted by that particular student to one or more selected students accessing that course page instead of all students accessing that course page.

In this aspect, this embodiment provides Dynamic Learning Groups which enable social interactions between students Course Administrators can create and manage one or more Dynamic Learning Groups, i.e., peer groups of students who will have social learning interactions as they go through a course. These groups can be used to provide fine-grained access control to student-generated content such as posts, discussions, forum questions and homework assignments outputs. This feature allows students to choose, on a post-by-post basis, which of their peer groups will be able to see the post and interact with them around that content. Moreover, on a post-by-post basis, students can select individuals from their available Dynamic Learning Groups who will be able to see and interact around the current post. In other words, just as is true in in-person training programs, users can choose exactly what they share and with whom, and they can create these Dynamic Learning Groups around any given learning activity or topic of interest, and in addition, in this embodiment, they can do so without needing to be physically and temporally co-located, which is novel.

This functionality provides several advantages over existing systems. When a course has large numbers of students, sharing posts between all students in the course becomes unwieldy very quickly. Supporting posting to selective subgroups overcomes this problem. For example, in a teambuilding course provided to a company of 10,000 employees, it would not make sense for every student to post all their comments to everyone in the company as pretty soon there would be many thousands of comments on each page, which creates information overload and degrades value. However, it would make sense for students to post their comments to other people on their same working team so that they could share with each other their thoughts about their own team development.

Similarly, in a course on project management that guided students through solving a real-life project management challenge they were facing on their team, it would not make sense for students to share comments with other students from other project teams who were working on totally different projects, but it would make sense for students to share their comments with their project team members who were working on the same project. Moreover, supporting posting to selective subgroups enhances privacy and selective sharing of information. There are often things people may want to share with selective people or groups that it would not be appropriate for them to share in a more public forum.

While the concept of peer groups as such is known, a novel aspect of Dynamic Learning Groups is that they are learning-content and learning-activity-centric, in other words, the social interactions are naturally organized around the learning activities, rather than being organized separately from individual learning activities, which is the case with other systems. For a given course page, teachers can define the default student groups that comments will be posted to on that page. These default settings may be set to share comments with several groups, or just to a single group. By assigning these default group settings for posts on a course page, teachers can in essence define “breakout groups” for course activities, with those breakout groups selected by the teacher to maximize social learning interactions—much as teachers would in real-world classrooms, only without the need for physical and temporal co-location of students.

In an embodiment, users can, for individual comments, override the default settings to choose which group(s) and even which individuals within those groups that specific comment will get posted to. When a user looks at the course page, they see all the comments against that page that they have access rights to—in other words, they see all the comments against that course page posted to any groups they belong to, plus any posts assigned to them as an individual.

In the prior art, Facebook™ social network users can create arbitrary groups. Such groups support interactions amongst members of each group. The content people interact about within a given group can be any of common content types, e.g., textual messages, pictures and videos. However, all group interactions and shared information is organized by group, not by content. Moreover, content cannot span groups, unless people re-post their content in multiple places. And in that case the social interactions around the content posted in multiple groups is partitioned off into each group.

The already-mentioned Moodle™ system allows a teacher to assign an activity to a group, known as a “student forum”. However, once they have done that, the interaction itself happens in a distinct location on the website: the student forum. In other words, the actual interaction between group members happens separately from the learning content, and the Moodle™ approach, thus, is limited to interactions that are group-centric rather than learning-content-centric. Like in the Facebook™ group feature, if someone wants to post the same content in multiple groups they have to do it by manually re-posting in several groups. Users cannot choose on a post-by post basis which group(s) the post will go to—all their posts go to precisely the group within which they are currently posting, and the social interactions posted in multiple groups is partitioned off into each group.

In a further embodiment the system comprises means for dividing the plural students into plural student groups, a given student being able to view only the posted comments by students being member of one or more student groups the given student is a member of as well. More particularly, these means may allow each member of a particular student group to limit visibility of any particular comment posted by that member to one or more selected members of that student group instead of all members of that student group.

Optionally, a course administrator may be allowed to restrict, on a course-page-by-course page basis, which of the plural student groups that the particular student is a member of will be available for the student to post comments to on the given course page.

In a further embodiment, in addition to the posted comments, each student is presented with any comments assigned to him in particular, regardless of whether such comments are related to the course page as part of which they are presented.

In a second aspect, an embodiment provides a system for supporting electronic learning over a network to plural students, comprising course provision means for the plural students to access courseware in the form of one or more course pages individually accessible over the network, comment presenting means for inserting comments into each course page, said comments having been previously posted by students accessing that course page, allowing students accessing that course page to view the posted comments as an integral part of the course page, commenting means for allowing a particular of the plural students to post one or more further comments for that course page, which one or more further comments then are inserted into the course page by the comment viewing means, and limiting means for allowing the particular student to limit visibility of any particular comment posted by that particular student to one or more of plural mentors who have been assigned to the particular student.

In this aspect, this embodiment provides Dynamic Mentor Groups which enable mentoring (i.e., “teaching”) interactions between students and defined sets of mentors or teachers. Course administrators can create and manage one or more Dynamic Mentor Groups, which are groups of mentors assigned to groups of students. These Dynamic Mentor Groups provide fine-grained control over which mentors will see which students' comments. While the concept of course mentors as such is known, a novel aspect of Dynamic Mentor Groups is that they are learning-content and learning-activity-centric. Moreover, the Dynamic Mentor Groups that are available for students to post to on any given course page can be configured by course designers, allowing course designers to assign specialized mentor teams (i.e., specialized domain experts) to specific course pages.

A key difference between Dynamic Learning Groups (described above) and Dynamic Mentor Groups (described here) is that students are members of their learning groups, while they are assigned to Dynamic Mentor Groups. When a student posts a comment to a Dynamic Mentor Group, all the Mentors in that group can see the post, but other students assigned to the same Mentor Group cannot see the post. This however does not preclude a system in which both Dynamic Learning Groups and Dynamic Mentor Groups are made available to students.

In an embodiment Course Administrators may define, on a course-page-by-page basis, which mentors or groups of mentors will be able to see posts to that page. For example, in a general management course, one page may, by default, allow posts to Finance mentors, while another page may, by default, allow posts to Leadership mentors.

In a further embodiment a student can select, on an individual post-by-post basis, which of their available Dynamic Mentor Groups on that course page they will post a comment to, and also select individuals from their available Dynamic Mentor Groups who will be able to see the current post. In other words students can choose exactly what they share with which of their mentor groups and individual mentors.

In a yet further embodiment students can indicate, on a post-by-post and mentor-group-by-mentor group basis, whether they want a response from a mentor in that group. If a student indicates that they want a response, then the mentors in that group will automatically be notified of the request for a response by, for example, and automated email notification or system message. Moreover, each mentor is provided with a list of all open questions assigned to them (i.e., to them individually and/or to mentor groups to which they belong), so that they can efficiently manage tracking and responding to those questions assigned to them. Once a question has been answered by a mentor, it is automatically removed from the mentor's list of open questions. This has the benefit of mentors of being able to read comments posted to them on their own schedule for general review of students' progress, while being notified of questions that need more immediate attention, to which they can respond more quickly with a tool for managing their open questions.

As some Dynamic Mentor Groups may be entirely unimportant or irrelevant to a given course page, Course Administrators may optionally select whether any given Dynamic Mentor Group will be visible as an option for student posting on that page.

In a further embodiment, for a given course page, Course Designers can define default Dynamic Mentor Groups that comments will be posted to against that page. These default settings may be to post comments to several Mentor groups, not just to a single Mentor group.

In a further embodiment, for individual comments, students can override the default settings to choose which Mentor group(s) and even individuals within those Mentor groups that specific comment gets posted to. When a Mentor looks at the course page, they see all the comments against that page that they have access rights to—in other words, they see all the comments against that course page posted to all Mentor groups they belong to, plus any posts assigned to them as an individual.

Mentors are optionally also provided with views that allow them to see all the comments that have been posted to their mentor groups in one place.

The inclusion of the option for students to tag a specific post as a question to a specific group of mentors (or to specific individual mentors), triggering a notification to mentors along with insertion of the question into a list of open questions assigned to each mentor, is a novel feature.

In the prior art, Facebook™ social network users can create arbitrary groups and allow others to post into those groups. Such groups support interactions amongst members of each group. The content people interact about within a given group can include content types such as textual messages, pictures and videos. However, all group interactions and shared information is organized by group, not by content. Moreover, content cannot span groups, unless people re-post their content in multiple places. And in that case the social interactions around the content posted in multiple groups is partitioned off into each group. In addition, in Facebook™ Groups, anyone who can post to a group can also see the posts by other people to the same group, while in Dynamic Mentor Groups, students cannot see posts by other students to the same Mentor Group.

The already-mentioned Moodle™ system allows a teacher to create “Question and Answer” forums, in which a teacher poses a question and students provide answers. In some ways, this is the opposite of Dynamic Mentor Groups, where students post comments to Mentors, which may include questions to their mentors. Moreover, the Moodle™ “Question and Answer” forums allow students to see posts by other students into the forum, while our system prohibits students from seeing other students' posts into the forum while allowing mentors to see all posts into forums they have access to.

Again in Moodle™ the interaction itself happens in a distinct location on the website, the Question and Answer Forum. In other words, the actual interaction between students and their mentors happens separately from the learning content, and the Moodle™ approach thus is limited to interactions that are group-centric rather than learning-task-centric. Like in the Facebook™ group feature, if someone wants to post the same content in multiple groups they have to do it by manually re-posting in several groups. Users cannot choose on a post-by post basis which group(s) the post will go to—all their posts go to precisely the group within which they are currently posting, and the social interactions around the content posted in multiple groups is partitioned off into each group.

In a third aspect, an embodiment provides a system for supporting electronic learning over a network to plural students, comprising course provision means for the plural students to access courseware in the form of one or more course pages individually accessible over the network, note taking means for enabling each of the plural students to record notes for a particular of the one or more course pages and for associating the recorded notes with the particular course page for which they were recorded, and note accessing means for presenting a predetermined set of recorded notes for a particular student on a single overview page in a graphical overview in a structured fashion with predefined cells that each are to contain particular types of notes, each cell that actually contains a recorded note being configured with a hyperlink that enables access of a particular course page for which the recorded note was recorded.

This aspect provides Structured Notes Management, which allows users to make notes in situ as they go through a course, and have those notes presented back to them in structured forms (hereinafter called Structured Notes Pages) that summarize their notes in a graphical presentation that both captures their notes and reinforces the key learnings of the course both through the graphical layout of the Structured Notes Pages and through system-generated comments and prompts for learners Course designers can use the layout of the Structured Notes Pages to capture and present to students conceptual relationships between elements of the Structured Notes Pages.

In several prior art bulletin board systems such as the open source MyBB bulletin board system, users can employ a search function to see all the posts of a given user in one place on a single page. The search results page then comprises the titles and all or part of each post, together with hyperlinks to the original posting location. This overview listing of posts by the user can typically be sorted by various criteria such as the date posted or the title of the post. However, this view does not support the presentation of a structured, graphical layout of the posts by a user according to a graphical representation of the conceptual interrelationships between various original course page locations (which have associated semantic importance) that the user posted to.

In the prior art of Mind Maps developed by Tony Buzan or other conceptual mapping models, such as the concept networks implemented in the cmap tool developed at the Florida Institute for Human and Machine Cognition, users can develop graphical maps or networks of the interrelationships between information. Using such graphical representations has proven to be a valuable tool for note-taking and learning. However in these tools, the conceptual maps are developed by end users as a means to develop their own model of the materials they are learning.

In contrast, in the current subject disclosed herein, course designers define the conceptual relationships they want to teach and design in a graphical representation that captures and represents those conceptual relationships within which students enter and edit their notes. This allows course designers to define the conceptual model students will use and then require students to use that model both in hypothetical case studies presented by course designers and to use the same model in their real-life applications. This allows course designers to present problem-solving and learning tools that incorporate interrelationships between information in a graphical form, which aids students' understanding and use. Moreover, each element of a structured notes page has a link back to the course materials where the usage of that element is described, which is a unique feature. This allows students to refer back to teaching materials as they review and edit their summary Structured Notes Pages.

In one embodiment the summary Structured Notes Pages are presented as two-dimensional arrangement of nested rectangles. In an embodiment, the summary Structured Notes Pages could be presented as two, three or more dimensional arrangements of any shapes in a Cartesian space. In an embodiment, the summary Structured Notes Pages can be represented as networks of interrelationships (similar to those supported by the above-mentioned cmap tool) but with the unique features that the relationships are be defined by course designers and not students, and each node of the network contains a link back to the relevant teaching material (i.e. course page) for that node.

In one embodiment users can view and edit the same information from two different views. One view is presented as students go through the course. In this view they see individual cells of a Structured Notes Page on the corresponding course page. If they have made entries for that cell on multiple instances of the Structured Notes Page design, then they will be able to see all their entries for that cell on the corresponding course page. When students post entries for individual cells of structured notes pages they have the same options for selecting which of their Dynamic Student Groups, Dynamic Mentor Groups and individuals within those groups will be able to see the post, just as they do for their regular posts against a course page Depending on privacy and group sharing settings, they may also be able to see entries made by other students for the same cell on that course page. Thus this view gives students detailed information that focuses on the learning or problem solving activity relevant to the current course page.

The second view is of an entire Summary Structure Notes Page. In this view, students can see and edit all their notes for the Structured Notes Page, within the graphical presentation as defined by the course designer to capture and reinforce conceptual interrelationships. Thus this view gives students an overview of their work product and problem solving process. The system provides links in both directions between these two views allowing students to move between the detail view (with learning materials) and the big picture view (with conceptual interrelationships) as they work on their projects.

For example, as a student goes through a course on negotiation, he may make notes about how he would apply the teaching on each course page to his own negotiation situation. The Structured Note Management module will automatically summarize their notes into a summary negotiation situation presentation that both captures the student's notes and graphically reinforces the key concepts of the course through placement of layout and titles of the cells on the summary Structured Notes Page.

Additionally, the contents of the Structured Notes Page cells can be edited by students. Further yet, when students make edits to a cell, their work will update the content of both the Structured Notes Page and their corresponding post on the course page for that cell.

These Structured Notes Pages may be used for revision, where a student can review one of their Structured Notes pages to see a summary of their notes and work product they created when they went through the course. Users can in such embodiments click on cells in the notes pages to go directly to the corresponding course page to review the teaching materials corresponding to that cell. Users can also see summaries of social interactions relating to each cell of their notes page and the notes page as a whole. This might include teachers' feedback on their notes and work product, which are especially useful for review.

An additional use of these Structured Notes Pages is that they can be used as a guide for working through additional real-life applications or simulated case studies after having completed the course. Students have the option to create new blank Structured Notes Pages at any time, entering information in each cell as they review the course materials or filling out the entire Structured Notes Page from the Summary Structures Notes Page view, or using a combination of both these views and processes to fill out their new Structured Notes Page. When a student creates a new blank Structured Notes Page from a course view, the type of the Structured Notes Page they create may be set by default to be of a type relevant to the current course page. Students also have the option to create new blank Structured Notes Pages from their Structured Notes Dashboard. In this case, students are presented with a list of the different Structured Notes Designs for the course (as defined by the course designer) and can select which type of blank Structured Notes Page they want to create. Once a student has created a blank Structured Notes Page, the blank page will be presented to him in his Structured Notes Dashboard with tools for editing the content of each cell. The blank cells will also show up on the relevant course pages, ready for editing. Students can enter and edit the contents of each notes cell in either the summary view or individually on each corresponding course page.

For example, after completing a negotiations course, a user can come back to the Structured Notes Page for the negotiation process and create a new blank Structured Notes Page for his current negotiation situation. He can then fill out that new blank Structured Notes Page with information about his current situation.

Each cell of the blank notes page will display a prompt as to what information should be entered into the cell and display a link back to the course content that provides the teaching materials describing how to fill out that cell. As users fill in each cell on the page, the prompts will be replaced by their own content, with graphical treatments that distinguish between course prompts and user content. As new blank Structured Notes Pages are filled in, they provide the same social interactions as the Structured Notes Pages they fill out as they go through the course: Users can comment on individual entries and on the entire structured notes page.

As students enter new information in their Structured Notes Pages, their entries will also be displayed as posts on the corresponding course page. This provides students and teachers with dual views of students' work products: One that gives summaries of notes and case study work product all on one page and the other that provides a view of individual cell entries, notes and dialogue on the course page that describes how to fill out that structured notes cell. This dual view is useful as it supports learners in moving from learning to application, and then from application back to deeper learning as necessary. Moreover it supports social interactions in both of these modes of learning and application, which increases social learning.

Course designers use a graphical interface to design Structured Notes Pages. In a preferred embodiment, the designs comprise several sections of text and/or graphics organized on a page in arrangements of nested rectangles.

Course designers assign each cell of a given Structured Notes Page to a learning activity page in the course. This assignment creates the link between each cell of the Structured Notes Page design and the corresponding course page that contains the teaching materials relevant to that cell Once this assignment has been made by a course designer, the Structured Notes Management module uses that information to present student entries for each cell of a Structured Notes Page on the correct corresponding course page, and to link back from each course page to the correct cell on the summary Structured Notes Page.

In a further embodiment, the system in this aspect comprises note presenting means for inserting into each course page one or more of the recorded notes associated with that particular course page, allowing students accessing that course page to view the recorded notes as an integral part of the course page. The system further comprises commenting means for allowing a particular of the plural students to post one or more comments to a recorded note as inserted into the course page, which one or more further comments then are inserted into the course page by the note viewing means.

In one embodiment, in any aspect one may provide a User Dashboard as an interactive tool for users to track and plan their progress within a given course. The user dashboard provides a repository of working materials and reference materials they create as they go through the course. The user dashboard presents a hierarchical outline of the course materials with graphics and text to show what activities they have completed already, what work product they have created, what activities they still have to complete, and summaries of social interactions with other users relating to each learning activity. The dashboard thus serves several functions for students:

An overview of what they have learned to date, along with links to their course notes to date which they can use for revision and reinforcement of learning.

An overview of what the they still have to learn, with summaries of the learning activities they still have to perform which they can use for planning, and which can provide them with motivation for continuing with the course.

Access to their Structured Notes Pages which provide them with structured notes for revision and for future re-use of the course materials to guide them through applying their learnings in new situations.

In addition to the User Dashboard, which in an embodiment has a full web page for viewing course progress, the system preferably provides a “Last Page Viewed” item, which can be displayed on any page on the website. This gives users an easy way of returning to the last page they viewed after they have navigated away from the course pages or after they have left the course site and later returned to resume their studies.

Further optionally one may in any aspect provide a Structured Notes Dashboard, where, learners can see their Structured Notes Pages laid out in the arrangement defined by the course designer. Users can also create new ‘blank’ Structured Notes Pages (the design of which is defined by course designers) from their User Dashboard.

Further, an embodiment provides a computer system for implementing the method and a non-transitory computer-readable medium comprising instructions for causing a programmable device to operate as the system of the invention.

### BRIEF DESCRIPTION OF THE FIGURES

Various embodiments will now be described in more detail in conjunction with the figures, in which:

FIG. 1 schematically illustrates the general principles of an embodiment, by way of an arrangement that comprises a server connected via a network to a plurality of clients;

FIG. 2 schematically illustrates the server in more detail;

FIG. 3 schematically illustrates a typical arrangement of educational material intended for use with an embodiment;

FIG. 4 schematically shows an embodiment of a student homepage for a given course;

FIG. 5 schematically shows a detail of the student homepage, notably the tab “All my posts”, of FIG. 4;

FIG. 6A schematically illustrates an embodiment of the Dynamic Learning Groups aspect of the invention;

FIG. 6B schematically shows an interface allowing a Course Designer to configure default settings for Dynamic Learning Group visibility,

FIG. 6C schematically shows an elaboration on the student view of the Post Comment functionality in the interface of FIG. 6B;

FIG. 6D schematically illustrates an embodiment of the Dynamic Mentor Groups aspect, including Mentor Group types;

FIG. 7 schematically illustrates an embodiment of a User Dashboard as provided for each student;

FIG. 8A illustrates how a course page may comprise an interactive form for making entries into the Structured Notes cell that is coupled with that course page;

FIG. 8B schematically shows an overview, comprising an aggregated view of all Structured Notes, allowing the user to quickly read all notes and jump to associated course pages;

FIG. 9 schematically shows an example of a Structured Notes Page as may be available in a particular course; and

FIG. 10 schematically shows an example of an overview of Structured Notes Pages, comprising a list of the structured notes pages the student has created and a form for creating new, blank structured notes pages.

In the figures, same reference numbers indicate same or similar features.

### DETAILED DESCRIPTION OF CERTAIN EMBODIMENTS

Before describing the various embodiments in detail, some key terms are defined herein for clarity.

Student: a person that uses the e-learning system for the purpose of studying and learning about one or more subjects. A student will often be enrolled at an institute of learning but this need not be the case. A student could also be an employee at a company or other organization or use the system without any third-party affiliation. The word “peer” is used to refer to students in the context of student-to-student relationships.

Mentor: a person who uses the e-learning system for the purpose of mentoring students in one or more subjects. Generally, mentors will be subject matter experts in topics covered by the courses provided. They have role definitions that allow them to view and respond to student comments. Moreover, their roles definitions allow them to be members of Mentor Groups, to which students can post comments and questions.

Teacher: a mentor who has a mentor role across multiple company groups. (All teachers are mentors, but not all mentors are teachers.) Teachers are usually professionals employed by an institute of learning or a training company but this is not required. Generally, teachers will provide services to students in multiple client companies or institutions, so teachers may be given access to view and respond to comments posted by students across multiple company or institution groups.

Administrator: a person that manages the e-learning system to facilitate use by teachers, mentors and students, including administration of student registration, course enrolment and management of Dynamic Student Groups and Dynamic Mentor Groups.

Course designer: a person who develops and designs courseware for use by teachers and students. A teacher may develop courseware himself and thus also assume the role of course designer. A course designer may also be an external person employed or hired by the teacher, company or institute of learning in question.

User: any user of the e-learning system, regardless of role. A given user could be provided with several roles (for example Administrator, Course Designer, Mentor and Student) In this case his abilities and interaction with the system would then be the combined abilities afforded to him by all the roles assigned to him.

Courseware: educational material, comprising any combination of text, audio, video, quizzes and other relevant content for teaching students about one or more subjects. Courseware may be part of one or more courses, e.g., a basic text on Greek culture could be part of an introductory course on the Greek language as well as a course on European culture.

Course: the set of courseware that focuses on a particular subject, for example a set of texts and audio recordings that together provide students with a basic knowledge of the Dutch language. In the system, a course is presented as a combination of pages, each containing some courseware that is part of the course.

Course page: an individual page within a course. Typically, although not necessarily, a course page will be presented on a single page of a website implementation. Typically, although not necessarily, students interact, post comments, ask questions and complete assignments at the level of individual course pages.

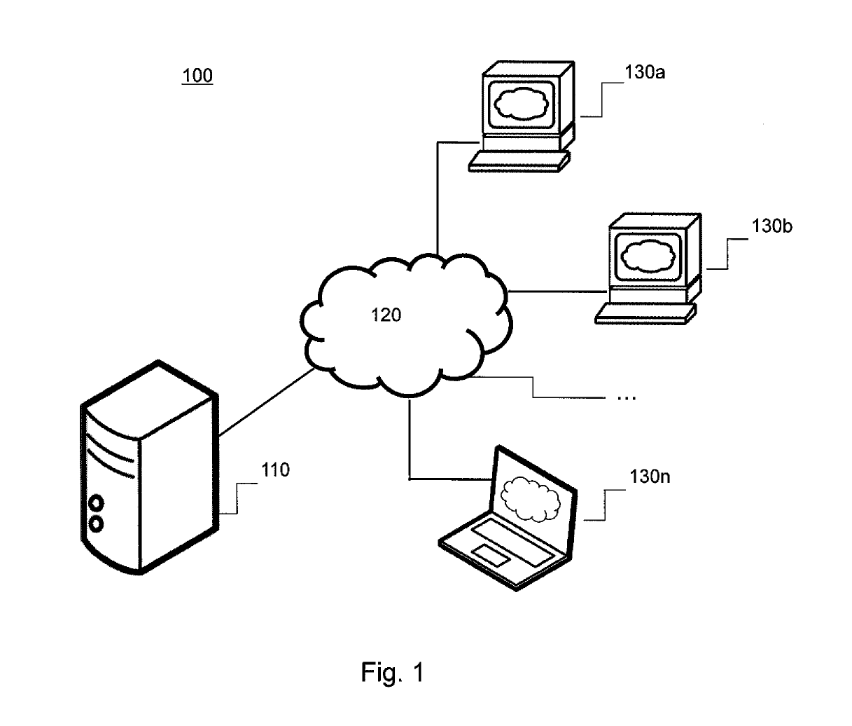

FIG. 1 schematically illustrates the general principles of one embodiment. An arrangement 100 is provided that comprises a server 110 connected via a network 120 such as the Internet to a plurality of clients 130a, 130b, . . . 130n, which, as shown, may comprise desktop computers and laptops, but also tablet computers, smartphones and other devices. As will be elaborated upon below, the server 110 is provided with hardware and software components that interact to deliver one or more e-learning experiences to users. The clients 130a . . . 130n similarly are provided with hardware and software components that interact to allow users to access and user the e-learning tools. The system 100 provides tools that support interactions that mimic in-person classroom training, without the need for people to be online at the same time to interact.

This embodiment may be implemented by configuring, customizing and extending (using PHP code and other methods) the generally available Drupal Content Management System, running on a Linux™ operating system, with an Apache™ server with MySQL and PHP, allowing users to access the server via standard Internet protocols. The basic structure of hierarchical course content with navigation links can be implemented using the Drupal Book module with modifications as outlined in this document.

In one embodiment, the system 100 provides support for the following teaching techniques which include both presentation and social interactions in the same environment:

Presentation of Materials and Ideas

Q&A sessions

Demonstrations

Role playing exercises

Case study exercises

Quizzes and test exercises

Personal reflection exercises

Exercises guiding users to develop their strategies, plans and reference materials related to the course topic (e.g., mapping out a business strategy, defining a customer management plan or creating a marketing message)

Instead of a single server 110 as shown in FIG. 1, one may employ multiple servers which can even be provided on geographically dispersed locations. The server 110 can be operated by the e-learning provider or by a third party, e.g., as a Software-as-a-Service or SaaS approach.

The network 120 preferably is the Internet but may also be a privately-owned network, e.g., an internal network operated by a company. That way only employees of the company can access the server 110, allowing the delivery of e-learning concerning company-restricted items such as internal policies or trade secret information. The server 110 in such embodiments can be hosted and operated by the company itself, or be remotely hosted. In the latter case, the server 110 typically connects to the privately-owned network over a secure Internet connection.

How and when the system 700 is deployed or made available to users is decided and configured depending on business model and teaching needs. For example, the system 100 may be deployed as an Internet-accessible course for any interested person. Typically, this requires prior registration and/or payment to access the course. In other situations the operator of the system 100 may pre-screen potential students or use some kind of identification to only allow certain persons to access the course, e.g., by requiring a registration code provisioned by a learning institution or company that is authorized to enroll students in the course or by authenticating the person through a whitelist of IP-addresses or other means.

Various registration schemes and user access controls can be accomplished by a combination of the core Drupal user registration functionality, preferably combined with the CAPTCHA module (for added security) and Registration Codes module, configured to provision new users with registration codes that automatically grant them certain roles and access rights such as: assigning student or teacher roles; assigning rights to and registration in certain courses; assigning them to specific company groups; assigning them to specific Dynamic Learning Groups and Dynamic Mentor Groups.

Public registration based on payment may be implemented using the Drupal Ubercart Module along with a third-party payment processing service, such as Google Checkout. Such public registration can be configured to provision a new user account after payment has been completed, and to grant the new user access to specific courses and other materials based on the products they purchased during their checkout process Customization of these modules also supports various payment and subscription services such as phased delivery of content and recurring subscription fees.

Additional delivery models such as making content available to users based on their activity on the site to date and pushing new content to users can be accomplished by appropriate customizations of the Drupal Actions and Triggers module.

The system may include various models for reminding and incentivizing users to participate in and complete each learning activity. Without active incentives and reminders to participate in online training, users tend to fall prey to “out of sight, out of mind” and attend to what is urgent in their daily work rather than what is important for their long term learning. Without incentives, students typically do not complete online courses, even if they think the course is valuable. Consequently, with online training, it is particularly important to provide incentives and reminders for learners to participate in and complete courses. Various mechanisms may be thought of, such as:

Automated reminders sent out by e-mail on a schedule triggered by the date of their registration.

Automatic reminders sent by e-mail to users based on rules based on factors such as their last login date and the last course activity they completed.

Automatic notifications sent by e-mail to supervisors, e.g., a dean, parent or manager, notifying them of any students who are not complying with mandated learning requirements, with the notifications triggered by rules based on factors such as users' last login date and the last course activity they completed.

Staged or limited-time availability of content (thus creating more of a sense of urgency).

Rule-based financial incentives, such as refunds of some or all of their registration fees based on how much of the course they complete within set timeframes.

Prizes and other incentives based on the quality of users' posts, or prize drawings for people who complete the program within a specified time frame.

Models for reminding and incentivizing users to participate in and complete each learning activity can be implemented using the Drupal Actions and Triggers module. Staged or limited-time availability of content can be implemented using the roles and subscriptions provisioning of Drupal Ubercart. Financial incentives for completing course content can be implemented using Drupal Actions and Triggers integrated with Ubercart and Google Checkout.

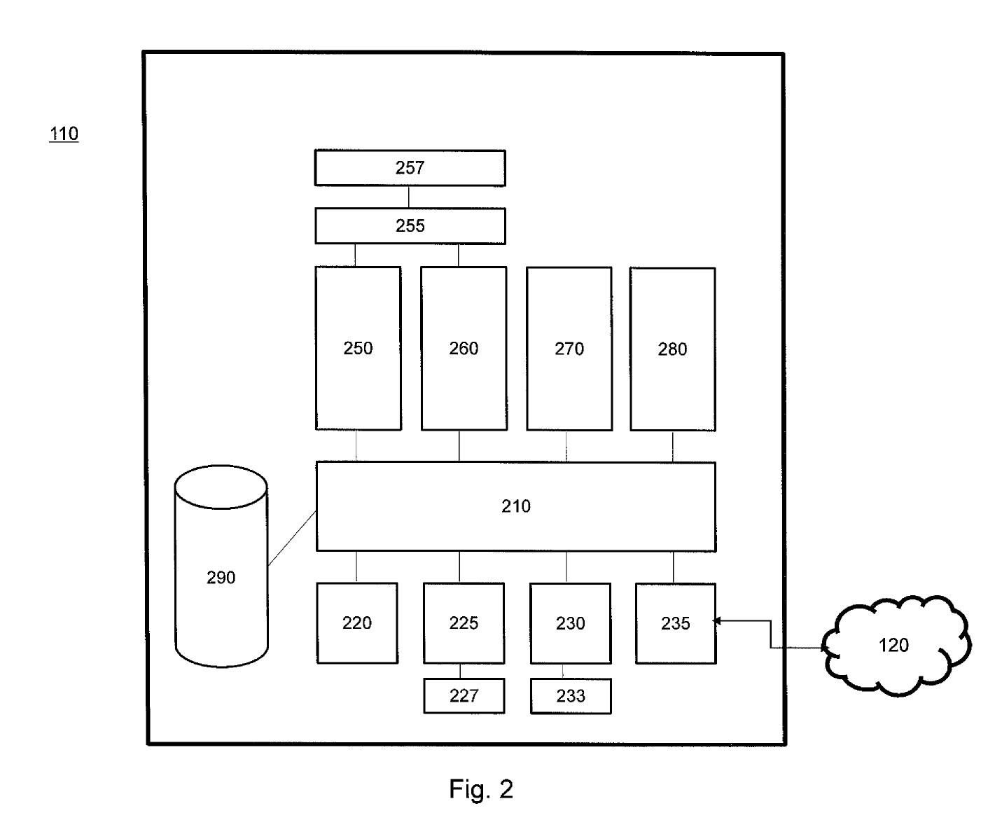

FIG. 2 schematically illustrates the server 110 in more detail. The server 110 mainly provides functionality through a central course management module 210, which coordinates and controls the various other components. The workings of each module will be discussed below in the context of each aspect for which the module(s) are relevant. But first, a brief identification of each module is given.

General functionality is provided by navigation module 220 which tracks navigational information, a rendering module 225 which compiles course content elements into a page for interaction with the user, optionally using branding module 227 to brand the page, and an access control module 230, with optional payment module 233, that manages login and registration of users. A communication module 230 is provided to enable communication with the clients 130a . . . 130n. This module 230 transmits the page as compiled by the rendering module 225 to the client that the user is using, and receives user input which is provided to the appropriate other rnodule(s) in the server 110.

More specific functionality is provided by dynamic learning groups module 250 that implements the Dynamic Learning Groups, mentor groups module 260 that implements the Mentor Groups, dashboard module 270 that provides the User Dashboard functionality and structured notes module 280 that provides the Structured Notes functionality. The modules 250 and 260 may optionally employ a discussion management module 255 to allow users to contribute to various discussions, preferably with ratings module 257 to allow users to give ratings to each other's contributions in the discussions.

The server 110 further comprises a database subsystem 290 for storing relevant data. It is to be noted that in practice the database subsystem 290 may be implemented as one or more separate database servers, that may exist physically in different locations compared to the location of the server 110.

As noted above, the various modules can and preferably are implemented using the generally available Drupal Content Management System as a basis. Drupal provides a mechanism for implementing extensions and modules, and through the Drupal community many existing modules are available that may serve as a basis for implementing the modules indicated in this document. Where appropriate a reference to such modules is included. At the time of writing, these modules are available through a simple name search at <drupal.org/project/Modules>.

Through access control module 230, login and registration of users can be managed. Before logging in, users will be presented with a login screen, where they can also register for a new account. After logging in, users will be presented with a display of the courses they are currently registered in, and optionally a summary of their progress to date in each course. A user then selects the course they want to work on by clicking on a course link. From then on, the pages they see are specific to the current course they have selected.

Individual students may be enrolled in multiple courses available on the system. In an embodiment, users are provided tools for logging on to the system and navigating to the course (and then around the course) they are currently working on Tracking of which courses a student is enrolled in and corresponding control of which courses a student has access to can be accomplished by the Drupal Roles module. User tools for navigating their various courses can be implemented using custom PHP code modifying standard Drupal Book navigation and/or creating new custom Drupal Blocks.

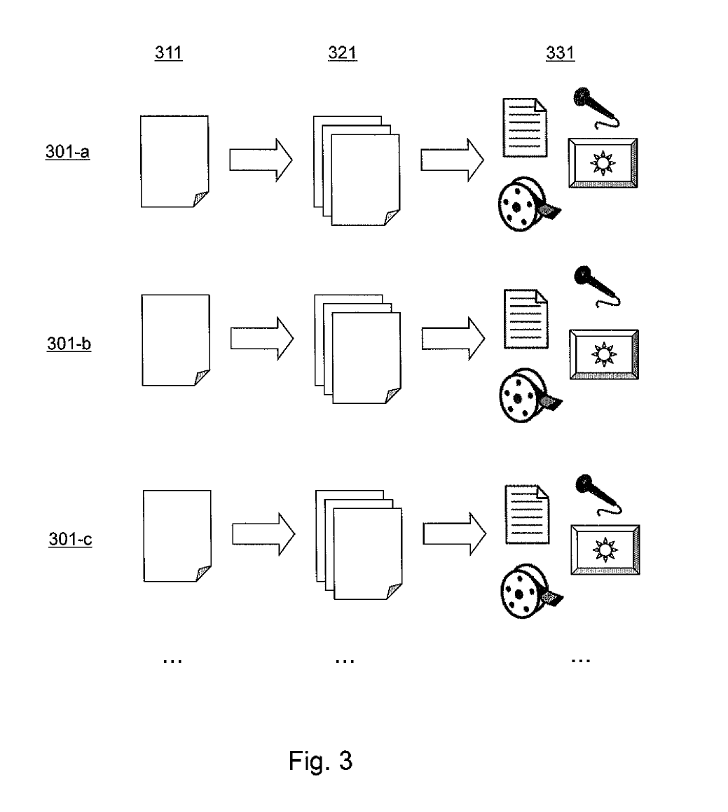

FIG. 3 schematically illustrates a typical arrangement of educational material intended for use with the system 100, Courses are structured in a hierarchical fashion, in much the same way as traditional course workbooks, with each course 301a, 301b, 301c comprising chapters 311, each chapter 311 comprising sections 321 and each section comprising course pages 331. Course pages are the lowest-level unit of a course and are presented as a single item on the screen when a student takes a course.

Each course page presents a particular learning activity. Course pages comprise courseware in the form of text, graphics, audio, video and interactive content (such as quizzes, simulations, interactive forms and exercises). Audio and video content is typically played in situ using graphical media player controls Many solutions are available for delivering course content. For example, embedded audio players can be implemented with a customization of the Drupal Audio module or with public domain JAVA™ audio player controls. Embedded video players can be implemented using third-party video hosting services such as ScreenCast.com™ or Youtube.com™, using their script-based video players to play video content within book pages.

The navigation module 220 tracks for each course page 331 relevant navigational information and causes the rendering module 225 to present to the user the content of a course page 331 with a navigation structure for moving around the course content in a way that is intuitive and matches the structure of the course (previous page, next page, going up to higher levels, digging down into detail levels).

Course content pages may ask questions of users, assign them exercises to do, present interactive quizzes for them to complete or give them cells of Structured Notes to fill out. Structured Notes are customized to the specific course at hand, giving students structured forms to fill out which include fields with labels and instructions.

Optionally, the ratings module 257 may be configured to allow users to rate each course page. This can be useful for continuous improvement of course content.

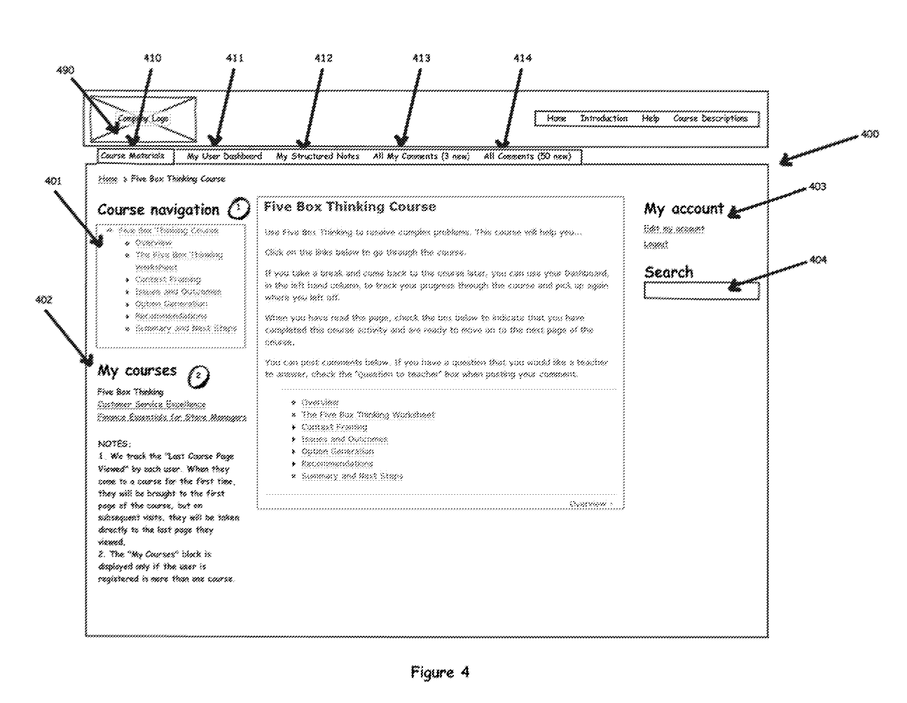

FIG. 4 schematically shows an embodiment of a student homepage for a given course. The home page 400 provides a course navigation structure 401 for moving around the course, and a set of tabs 410, 411, 412, 413, 414 providing links for accessing other information specific to the course, including their. User Dashboard or Progress Tracking page, their structured notes, their comments in the course, and other users' comments in the course. If the user is enrolled in plural courses, a further navigation structure 402 enumerates these courses and allows quick access to each of them. An account management structure 403 and search feature 404 is present at the right, as is common.

The dashboard module 270 manages the User Dashboard, the repository of working materials and reference materials that users create as they go through a course. The User Dashboard can be built upon a modular activity system. For example, each course page may be extended with an activity definition in the database and user progression of an activity is set by the specific activity class. Depending on the class, this activity information may be stored in the database as a separate table, or dynamically determined during a query. The User Dashboard accesses these functions and aggregates the responses of the activity classes to display in a formatted view.

In an embodiment the rendering module 225 includes a branding module 227 that adjusts the presentation of course content in accordance with certain externally-supplied branding requirements. For example, particular color schemes and fonts may be used, a specific logo can be presented in the top left box 490 and textual or graphical elements may be added as header and/or footer to the content. This embodiment further enables the white-labeling of courses, that is the provision of common shared content to different customers under different brands.

In this embodiment, the actual course content will be common to all sites, while user comments from a particular user group such as one company (“Company Groups”) will be displayed only to other users from that same group. However optionally course teachers are able to see all user comments from all customers for a given course across multiple Company Groups, aggregated into a single location. If a course teacher then replies to a comment in this aggregated view, the reply will only be displayed on the site (i.e., to the Company Group) in which the original comment was made.

The Company Groups embodiment provides refined access controls to limit users' access to course content and views of other users' posts at the highest level (e.g., partition user groups belonging to different companies so that users from different companies can never see each other's posts), which can be accomplished by incorporating the Drupal Organic Groups module into the branding module 227. In this case, company employees are assigned to the Organic Group representing their company. To associate course content (a.k.a. Drupal Books) with the company groups, top level book nodes are assigned to the correct user groups. Functions are provided in a custom module to facilitate lookup of which groups node a child book page belongs to.

The system 100 in an embodiment supports subscription-based access to courseware. This requires addition of a payment module 233 that keeps track of any payments made and signals the course management component 210 that particular course content is to be available—or is no longer available—to a particular student. With this information the access control module 230 may enable or disable users' access to particular courses and content after they have logged in. Particularly useful subscription-based access models include:

All at once—a subscriber has access to the entire course content as soon as they subscribe.

By phased delivery—subscribers get access to content in a phased manner. This is particularly useful for maintaining users on paid subscription services.

Based on their activity—subscribers get access to new content once they have completed specific learning tasks. The new content may give them more information about a particular area of interest, or give them the next phase in a linear learning process.

Pushed to users—in some cases it is useful for new course content to be pushed to users at specific times, for example if new government legislation requires a change in operating procedures, then training about the new operating procedures could be pushed to all affected staff simultaneously.

The tools supporting interactions of students with the learning materials and interactions between users are context-specific, typically but not always based around individual course pages or Structured Notes pages. User posts such as responses to learning assignments, Q&A and group discussions relating to a specific learning activity are displayed on the same course page as that that learning activity is displayed. This means that whenever a user is engaged in a specific learning activity, the social, or user-created, content they see will relate to that specific learning activity at hand.

An important aspect of courses is the social interaction between students. Courses offer discussion forums on each course page which provide vehicles for discussion, questions and debate among students, or between students and their mentors. A discussion management module 255 enables students to post texts or other items to initiate a discussion or to reply to existing items posted by others. This includes the ability to mark certain responses as private or public, or assign specific predefined groups or dynamically chosen groups of individuals that can read the response, as discussed below in the Dynamic Learning Groups aspect. This enables sharing of information between subgroups to stimulate specific discussions or feedback between members of only those subgroups but not others.

Teacher-student interactions may, in addition to the exchange of comments as shown, include presentation of materials and ideas, question and answer interactions, guidance from teachers to students and feedback and coaching from teachers to students. Student-to-student or peer-to-peer interactions concern features such as group discussions, paired and group exercises, informal learning through conversations between students about particular learning tasks and applications and the development, and use of course structured notes. Of course various forms of examination and testing of students' knowledge and/or skills are also available.

The discussion management module 255 comprises code to allow users to post their responses to the tasks, questions and assignments provided in each course page 331 on the same page as the corresponding course page 331. Their responses will appear in situ on the corresponding course page, so from the user's perspective, posting a response or filling out a structured notes cell entry will be analogous to writing information in their own course notebook—only their responses will be online and they will be able to see and learn from other users' responses as well. In addition course instructors will be able to see students' responses and interact with students based on their responses. Moreover, the groupings of people who can see these responses and interact with them for social learning can be defined both statically and dynamically by the discussion management module.

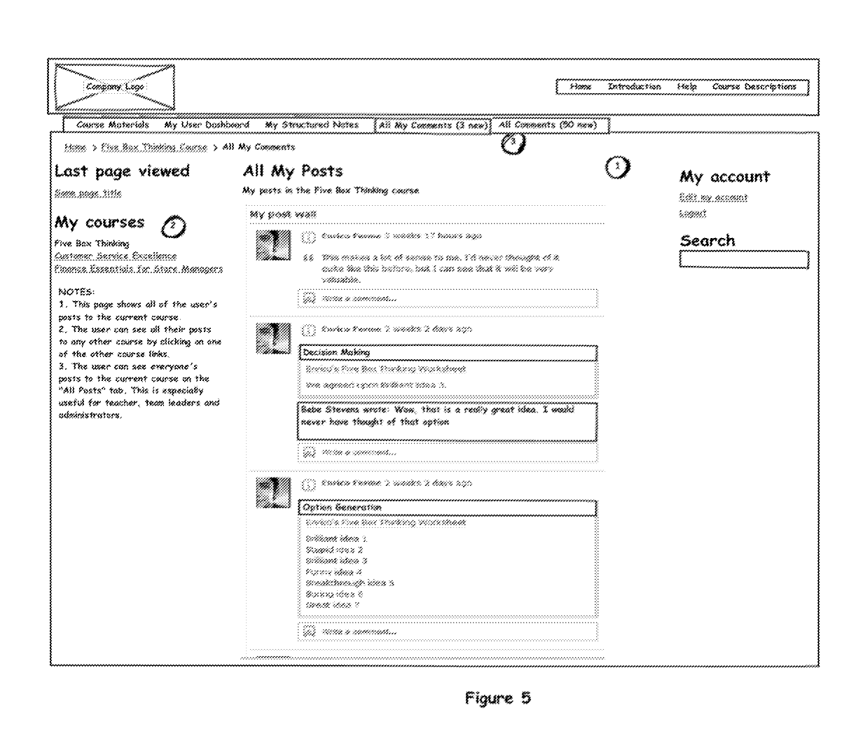

On any given course page, the system provides a way for users to easily see their own posts (and responses to them) separate from posts by other users. In an embodiment, this is accomplished by sorting the current user's comments to the top of all user comments on a given course page, so that the current user can always find and see their own contributions easily. In another embodiment, comments may be sorted by the Learning Groups and Mentor Groups to which the comments were posted. Furthermore, as illustrated in FIG. 5 a student may access all his own comments or contributions in one place from his student homepage, using the tab 413 “All my comments” from FIG. 4.

Optionally users may be able to rate each other's comments, or users with specific roles may be able to do so (for example, students may be able to rate each other's comments, or only teachers may be able to rate students' comments). In this case, ratings may be used for evaluating students and/or for sorting all comments against a given page, for example showing the highest rated comments at the top. User rating of comments can be accomplished by adding rating module 257 that is a customization of the Drupal Comment Rating module, combined with a custom implementation of the Drupal Views module for comment sorting according to ratings.

In a further embodiment, the discussion management module 255 is configured to allow a user to see other users' responses to any given course page only after they have posted their own response to that course page. This has the benefit of requiring that a user does their own original thinking before learning from other users' responses. This can be accomplished using a customized combination of the Drupal Node Comments and Views modules.

Many more options for improving the quality and value of responses are available if the discussion management module 255 is extended with customizations of the Drupal Notifications module, Subscriptions module and Comment Rating module For example, the discussion management module 255 may be configured to allow users to rate each other's responses. This may be enabled or disabled for a given user based on their role (i.e. student or teacher.) This enables a further refinement where user responses on a given course page may be sorted according to aggregate user ratings. Alternatively or additionally the discussion management module 255 may be configured to allow a particular user to receive an e-mail notification or other alert when another user posts a comment to that particular user's post. Alternatively or additionally the discussion management module 255 may be configured to allow users to subscribe to any course content or user response, in which case they will receive an e-mail notification or other alert whenever someone posts a response or reply to that content.

In a further embodiment, the Drupal Privatemsg module (not shown) may be employed to allow users to send private messages to each other based on username identities, in ways that protect the disclosure of real identities and real contact information of users to each other.

In an embodiment a user's response to a given course page can have a default setting, determined by the course designer, to be either public or private depending on whether the task is designed to elicit information that should be kept confidential to the individual user, or designed to elicit information that is intended to be shared with other users for social learning purposes. Such settings are preferably stored in the database 290, where also the posted comments and associated metadata are stored.

In an embodiment, the discussion management module 255 is configured to enable users to post comments and/or replies to each other's posts. These replies then are preferably displayed in a standard “threaded comments” organization on each course page 331. Support for threaded user comments with sorting and filtering of comments by various parameters can be implemented using the Drupal Node Comment module (for comments) and Views model for filtering and sorting of comments as a starting point.

In a further embodiment, the discussion management module 255 is configured to allow users to assign, on a response-by-response basis, whether they want that response to be made private or public. In this embodiment these user settings may be able to override default settings defined by course designers. The ability for users to make private comments, which only they will see, allows them to make personal notes about the course, disabling the default social interactions.

In a preferred embodiment, discussion management module 255 is configured to let a user select, on a post-by-post basis, which groups and individual users can see that specific post, thus creating dynamic learning groups. This embodiment is key to the Dynamic Learning Groups described below. In one implementation, the database 290 is configured to manage post/group assignments as a separate table, associating post identifiers and group identifiers. This allows the dynamic addition or removal of such assignments by updating this table as appropriate.

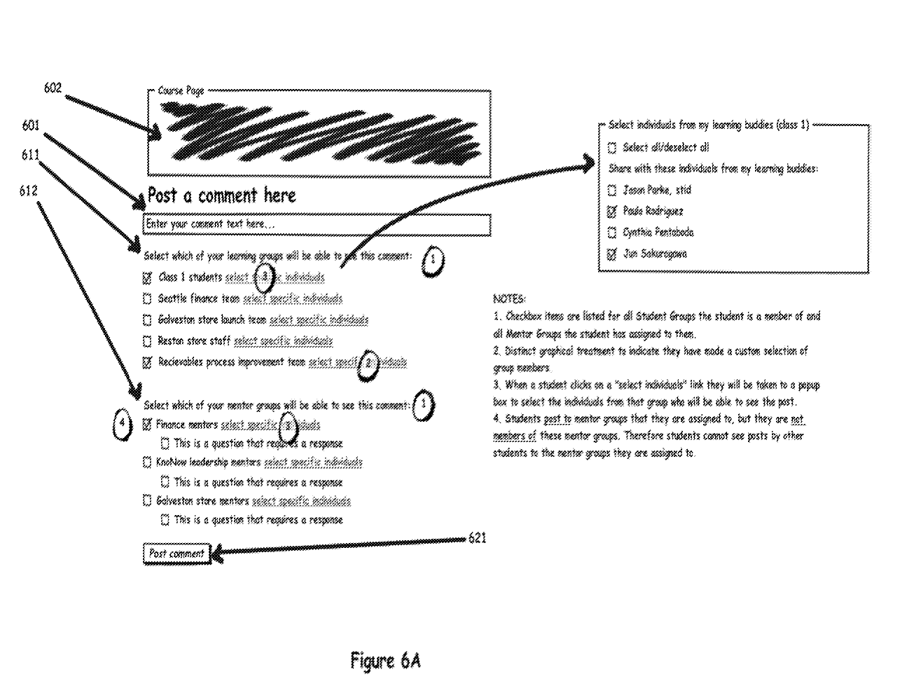

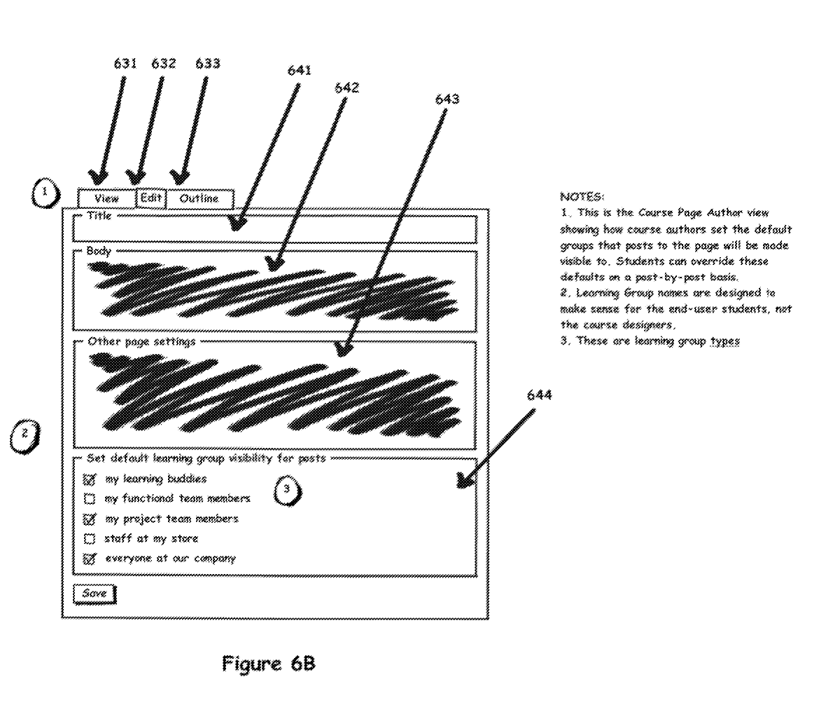

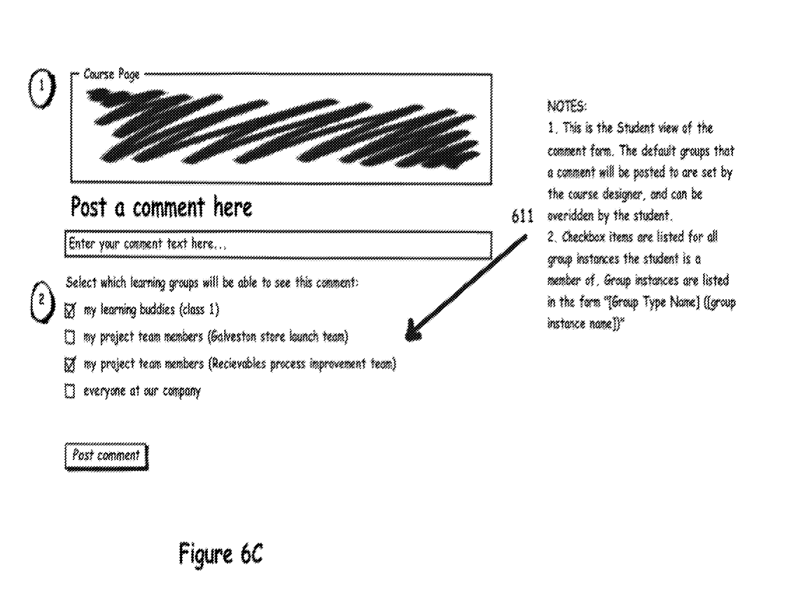

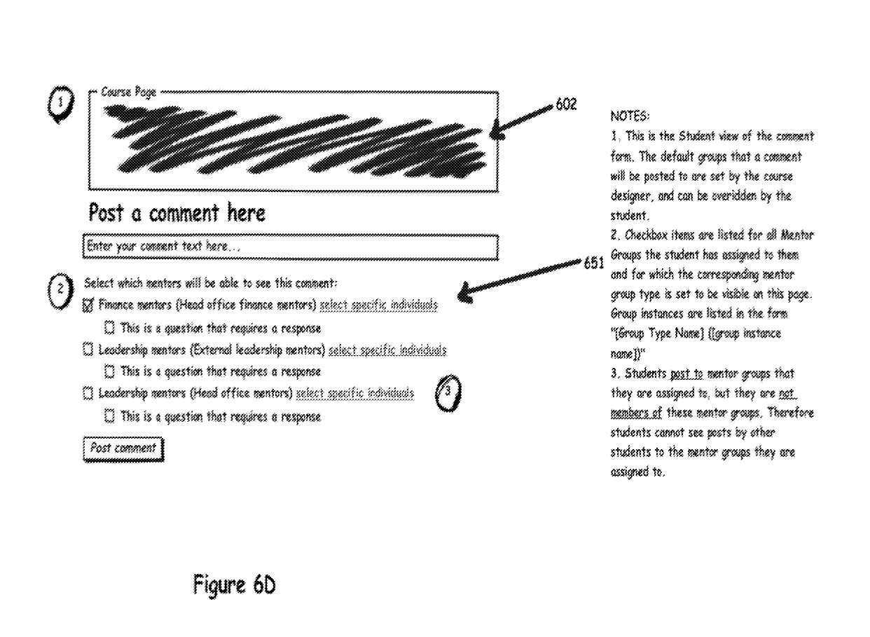

FIG. 6A schematically illustrates an embodiment of the Dynamic Learning Groups aspect. The dynamic learning group manager 250 allows users to be assigned to one or more distinct learning groups. Learning groups and their composition can be recorded in the database 290. Learning group memberships can be configured to support learning interactions between subsets of students in specified ways in relation to the course content. For example, all students in a specific department of a company may be assigned to a common learning group, so that they can have social learning interactions with each other, but do not see the activity of users from other departments. This way a course administrator can group students with similar background or requirements, or in contrast group students with very different perspectives to stimulate lively discussion. In this embodiment, any given user can be assigned to any number of learning groups.

FIG. 6A provides the user with a post comment form 601 that allows the posting of a comment in connection with a particular course page 602. In the illustrated embodiment, a user can select, on a post-by-post basis which groups and individual users can see that specific post, thus creating dynamic learning groups. To this end the learning group manager 250 displays in area 611 the five student groups the current user is a member of in the comment post form and allows in area 612 the user to select which mentor groups and individual mentors will be able to see the specific post they make with that post form, thus creating dynamic learning groups which support interactions around the comment posted by the user. As noted above, this enables sharing of information between subgroups to stimulate specific discussions or feedback between members of only those subgroups but not others Once a comment has been entered in form 601 and the appropriate selections from areas 611, 612 have been made, the user can submit the comment using button 621 below.

In a further embodiment, the learning group manager 250 comprises code to allow users to select which individuals from their available learning groups can see any specific post they make, thus creating further refinement of the dynamic learning groups which interact around the topic posted by the user.

In a further embodiment, course administrators can select which groups of each user will be presented to the current user on their post form, thus enabling course designers to restrict which learning groups a user can post to on a given page. This has the benefit of allowing course designers to establish which social learning interactions (i.e., which learning groups) will be permitted on each course page.

In a further embodiment, if a user joins a new group, he may be offered the opportunity to let all posts be accessible to members of the new group. Similarly, if a user leaves a group, all post assignments to the group that has been left may be removed, although optionally one may leave the assignment in place so as not to disturb the discussions and content available previously.

While the above mechanism for course administrators to select which learning groups will be available on each course page for users to post to is possible, it can also be practically difficult for course administrators to manage this, as with tens of thousands of users and thousands of learning groups, it may be prohibitively time consuming for administrators to make those assignments on an individual group-by-group basis.

To overcome this problem, in a further embodiment, the learning group manager 250 supports the definition of different types of groups which can be used to further extend how course designers and administrators can control and influence social interactions around course pages to maximize social learning.

With group types, course designers can define a relatively small number of group types, of which there may be many instances of each type. For example, in a general management course, a course designer might define group types of “my learning buddies”, “my functional team members”, “my project team members”, “staff at my store”, and “my company”. In this example, course administrators could then create multiple instances of the group type “my learning buddies”, each instance of which would represent a cohort of students ‘taking’ the course together, create multiple instances of the group type “my functional team members”, each instance of which would have as members a group of students who worked together in the same functional role, etc.

Once learning group types have been created, course designers can choose which types of learning groups will be visible on any given course page for students to post comments to. Thus for course administrators, it will be much more efficient to select default group visibility settings from a relatively small number of group types than from a much larger list of group instances.

These course page post settings may be established as default settings (La, pre-selecting which group types will be posted to by default by students posting to that page) and/or by completely hiding group types which are not relevant to the current course page, so students cannot post to their groups of that type.

Continuing the example, when designing a course page where social learning interactions between groups of “Learning Buddies” and “Project Team Members” would be beneficial (but social learning interactions between other types of groups would be irrelevant or even distracting), the course designer could set the default group type selections so that posts to that course page would, by default, be posted only to learning groups the student was a member of that were of those two group types.

FIG. 6B schematically shows an interface allowing a Course Designer to configure default settings for Dynamic Learning Group visibility. In FIG. 6B, at the top of the interface three tabs 631, 632, 633 are presented. Tabs 631 and 632 allow the Course Designer to view and edit, respectively, a particular course page. The tab 633 is presented for allowing the Course Designer to define where the particular page is arranged in the course in relation to other course pages. On the edit tab 632, the Course Designer may edit the title 641, body 642 and other page settings 643. Further, the Course Designer can control the visibility of default learning group types with control 644. The Course Designer makes these choices based on his or her experience as to what the best visibility for this particular course would be. Once the course designer has caused these default settings for a course page to be recorded in the database 290, the student view of the Post Comment functionality will be modified accordingly. As can be seen in FIG. 6C in comparison with FIG. 6B, the Course Designer has removed visibility of the Student Groups of “Seattle Finance Team” and “Reston store staff” by hiding visibility of groups of the types “My functional team members” and “Staff at my store” from area 611 of the student post form.

In an embodiment, in addition to setting default learning group types that will be selected on a student's post comment form for a page, course designers can choose to completely hide select group types as options for students to post to on that page. This might be used by course designers for example to prevent irrelevant or distracting social interactions or to protect privacy or partition information sharing to comply with corporate policy, social conventions or regulatory requirements.

Just as Dynamic Learning Groups can be implemented with or without learning group types, so too can Dynamic Mentor Groups be implemented with or without mentor group types. The same practical limitations on managing which Dynamic Learning Groups get displayed on each course page apply to Dynamic Mentor groups when group types are not implemented. The same benefits for course designers and administrators apply when Dynamic Mentor Group types are implemented.

FIG. 6D schematically illustrates an embodiment of the Dynamic Mentor Groups aspect including Mentor Group types. In this embodiment, like in FIG. 6A, the user is provides with a post comment form 601 that allows the posting of a comment in connection with a particular course page 602. However, in FIG. 6D a selection area 651 is present to allow the user to select one or more mentor groups. The mentor group manager 260 displays all the mentor groups a student is assigned to of the mentor group types the course designer has selected to be displayed on the current comment post form and allows students to select which of their available mentor groups and which individuals from those mentor groups will be able see any specific post they make, thus creating dynamic mentor groups that a student can use to share information with their mentors and receive various forms of feedback, evaluation and mentoring from their mentors.

While the Dynamic Learning Groups and Dynamic Mentor Groups share certain basic properties, and therefore the abovementioned features regarding Dynamic Learning Groups can easily be adopted for Dynamic Mentor Groups, a clarification of some differences is appropriate. Dynamic Learning Groups support selective social interaction between peer groups of students while Dynamic Mentor Groups support interactions between students and their mentors. When a student posts a comment to a Dynamic Learning Group, all the other students that are members of any of the selected learning groups will be able to see that comment and have social interactions around that comment in contrast, Dynamic Mentor Groups provide a way for students to post comments to mentors and have social interactions with mentors that may be hidden from other students. While students are members of their Learning Groups and can see posts by other students into those groups, students are not members of their Mentor Groups and cannot see posts by other students into their mentor groups; while mentors can see all posts by students into the Dynamic Mentor Groups to which they belong. Posting to a Dynamic Learning Group by a student is analogous to sharing a comment in class with other students, while posting a comment to a Dynamic Mentor Group is analogous handing in an assignment to mentors, or having a private mentoring conversation with a mentor, although in both cases this embodiment makes this possible without requiring physical or temporal co-location of the people involved in the interactions.

In an implementation, both the dynamic learning group module 250 and the dynamic mentor group module 260 are implemented on a customization of the Drupal Organic Groups module to provide common membership management and accounting. The distinction between the two kinds of groups is in how a student is related to that group, and the subsequent filtering that is applied to the post view for a given student.

First, a student is a direct member of a Dynamic Learning Group However, a student is not a direct member of a Dynamic Mentor Group They have a Drupal CCK field that points to a Dynamic Mentor Group which is then used to associate a student with his mentors.

Students posting on a course page to a Dynamic Student Group will have that post automatically assigned to the student's own group. Students posting to their Dynamic Mentor Groups will cause the system to traverse the CCK field and post directly into the Dynamic Mentor Group specified.

During construction of the view for postings, the system checks whether the student has rights to view the assigned groups associated with a given post. This allows the current student to see posts belonging to their Dynamic Student Groups. Additionally, the author of a post has rights to view the post regardless of the assigned groups. This allows posts to the Dynamic Mentor Group to be visible to the student that posted it, along with the associated comments from the mentor group members, but at the same time keeping it private from other students.

In the embodiment of FIG. 6D, the mentor group module 260 optionally allows users to select which individuals from their available mentor groups can see any specific post they make, thus creating a further refinement of the dynamic mentor groups that can see and respond to the topic posted by the user. For example, in a general management course, some course pages might cover finance, some customer service, some leadership and some conflict resolution Dynamic Mentor Group types could be set up for each of these areas of subject matter expertise, and then mentor group instances of each of these types would be created containing mentors with the specific expertise relevant to that group type (so there would be Finance mentor groups, Customer Service mentor groups, Leadership mentor groups and Conflict Resolution mentor groups).

Continuing the example, on a course page that contained learning content relating to finance, but also with possible implications for leadership, the course designer could make the default setting for posts on that page to be posted into all Finance mentor groups the student was assigned to, and allow the student to optionally choose to also post the comment to any Leadership mentor groups they belonged to The student in FIG. 6D is assigned to one instance of the “Finance Mentors” group type, namely the “Head office finance mentors” mentor group and the student in the example is assigned to two instances of the “Leadership mentors” group type, namely the “External leadership mentors” and the “Head office” mentor groups. Consequently these three mentor group instances are displayed in selection area 651 as the mentor groups in which the example student can choose to post.

This allows course designers and administrators to set up mentor groups and course pages in a way that allows mentor groups with specialized expertise to focus on (and in fact only see) the student comments that are relevant to their area of expertise. This allows for specialization of mentors, and maximization of their use of time in supporting students in their learning.

In a further embodiment, the discussion management module 255 is configured to allow users to flag individual posts as a “question to mentor” in which case the mentor(s) assigned to that user will receive an automatic notification that they have a question to answer. This functionality can be implemented through appropriate customizations to the Drupal Node Comment module.

Dynamic Learning Groups and Dynamic Mentor Groups can be implemented using customizations of the Drupal Organic Groups module integrated with the Drupal Content Construction Kit (CCK) module. Users can create posts specific to Dynamic Learning Groups and Dynamic Mentor Groups. This is accomplished via a node reference CCK field that points to the respective Organic Group group node for each post. Custom filters are provided for integration with the Views module to limit the posts that a user sees to their assigned groups.

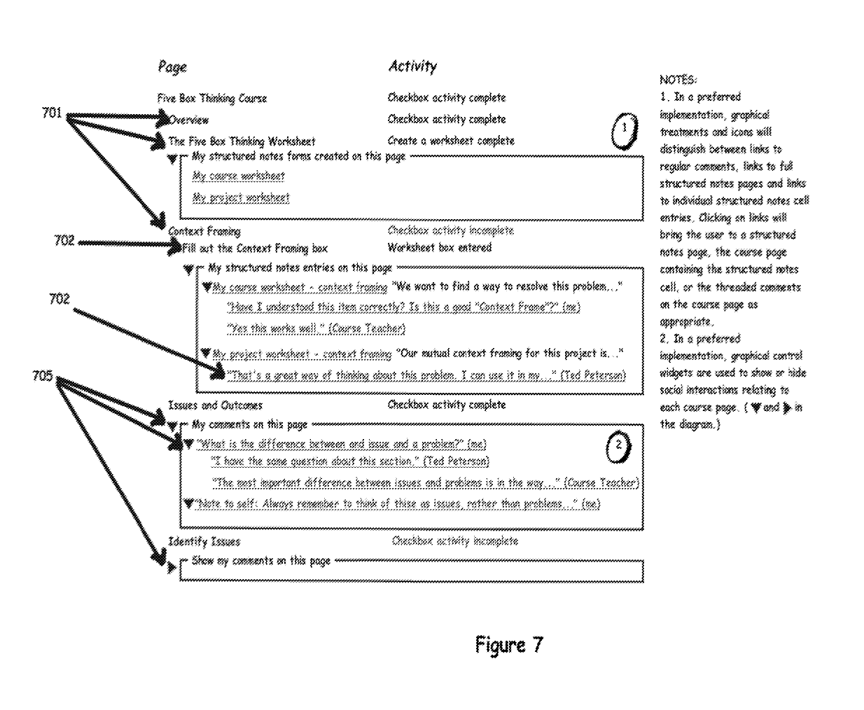

FIG. 7 schematically illustrates an embodiment of a User Dashboard as provided for each student. The User Dashboard, as generated by the dashboard module 270 and rendered through the rendering module 225, is the user's personal graphical overview of what they have accomplished so far in their training, the notes and reference materials they have created, and the remaining learning activities they still have to complete.

The presentation of the User Dashboard matches the hierarchical structure of the course design. The main titles 701 in the dashboard are the names of each top level course page 331, with sub-titles 702 indented to match the course structure. As shown in FIG. 7, active graphics 705 allow users to collapse and expand the sections of information displayed on their dashboard, so that they can hide or view more detailed information at any level.

Preferably, the dashboard module 270 causes the rendering module 225 to adjust the graphical treatment of title or content for each course page as included on the dashboard to indicate whether or not the user has posted a response to, or completed some assigned task for, the corresponding course page. This adjustment may be done by changing color, using a different font, adding a particular icon or any other method the skilled person may think of. This gives users a visual display of what they have completed and what the still have to do.

In an embodiment a preview 710 of the current user's responses is listed under the page title of a course page 331. This allows a user to easily keep track of responses and any related discussions with other users in response to the current users post. Such preview would typically be presented as a title and a ‘snippet’ of text from the body of the response. The preview might also include a reference to further responses or contributions to any discussions that the user response is a part of, for example by way of a textual reference such as “There are 3 responses to your comment.”

In case the user has not posted any responses or comments, or has not completed a required learning activity for the corresponding course page, the dashboard module 270 preferably causes the task description of the relevant course component to appear. This allows the user to see a description of what they still have to do to complete that learning activity.

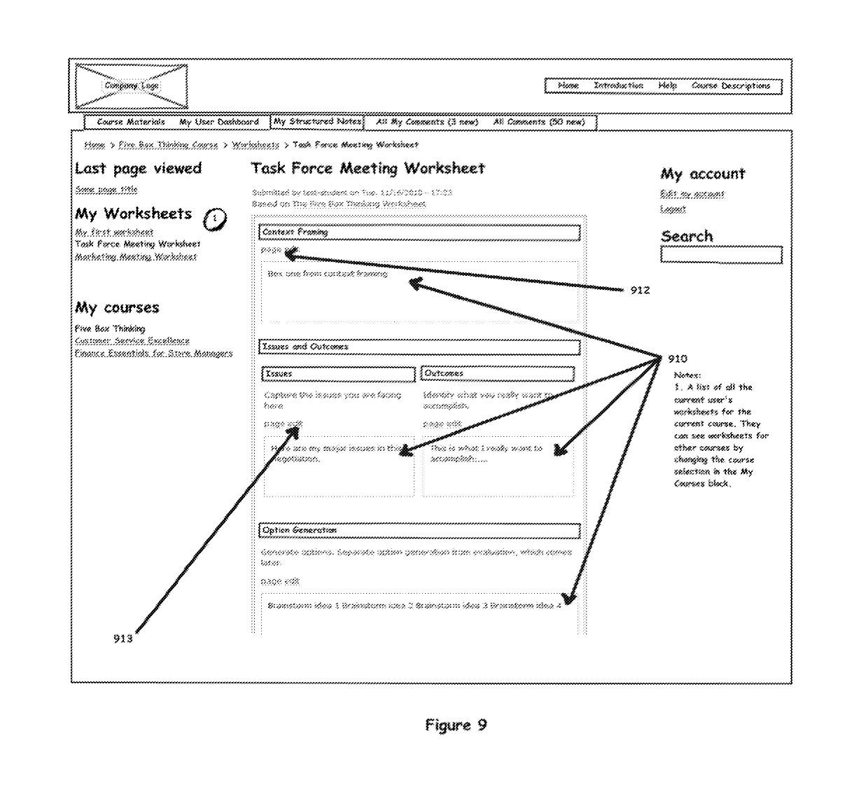

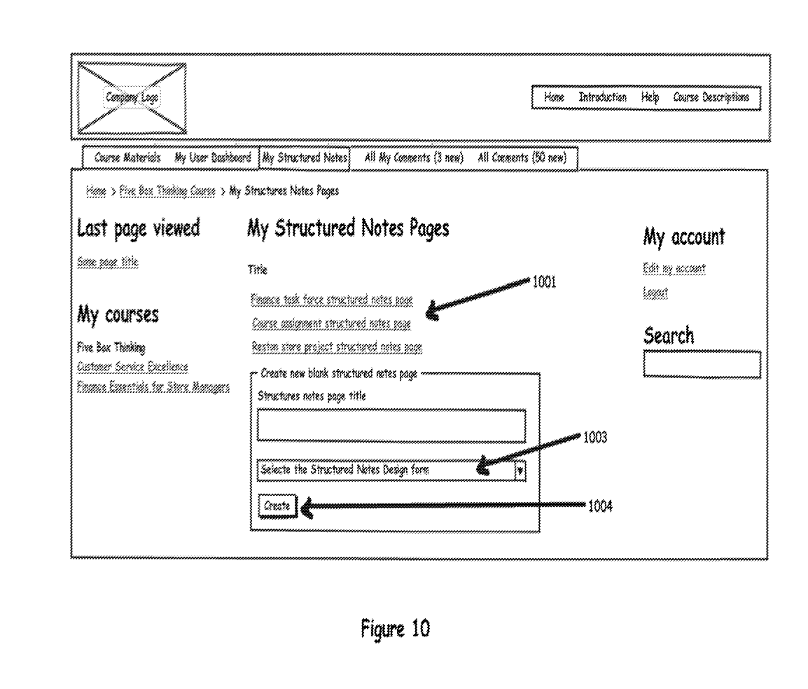

In one embodiment, for course activities where users fill out Structured Notes Page or otherwise post responses that capture the strategies, plans and reference materials they develop during the course, the system provides a My Structured Notes page, accessed through tab 412 in FIG. 4 which users can use for accessing and editing their structured notes after they have created their notes. An example My Structured Notes page is shown in FIG. 10. On this page, area 1001 displays a list of all the structured notes pages the current student has created in the current course. Clicking on one of these links will bring the student to the corresponding Summary Structured Notes page as shown in FIG. 9.

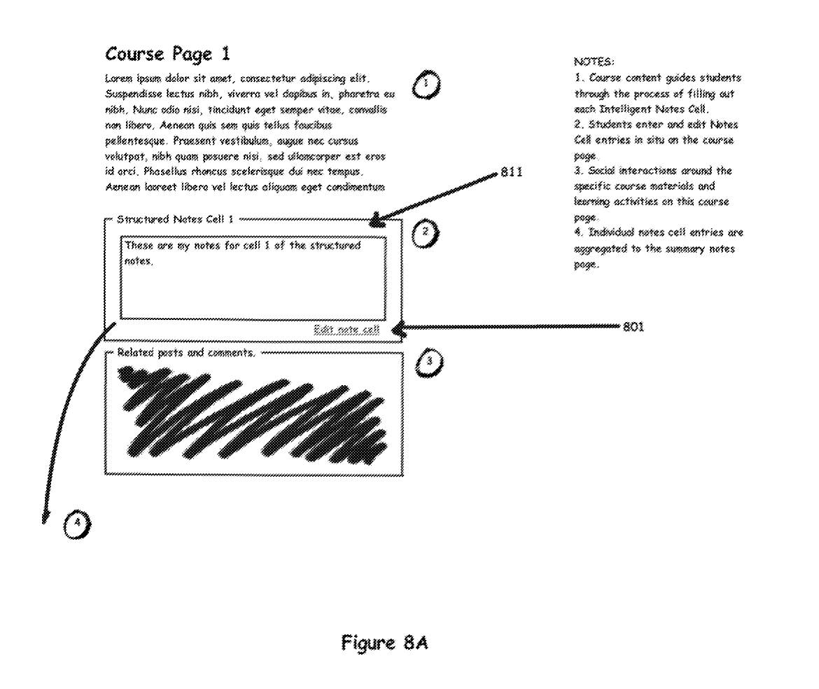

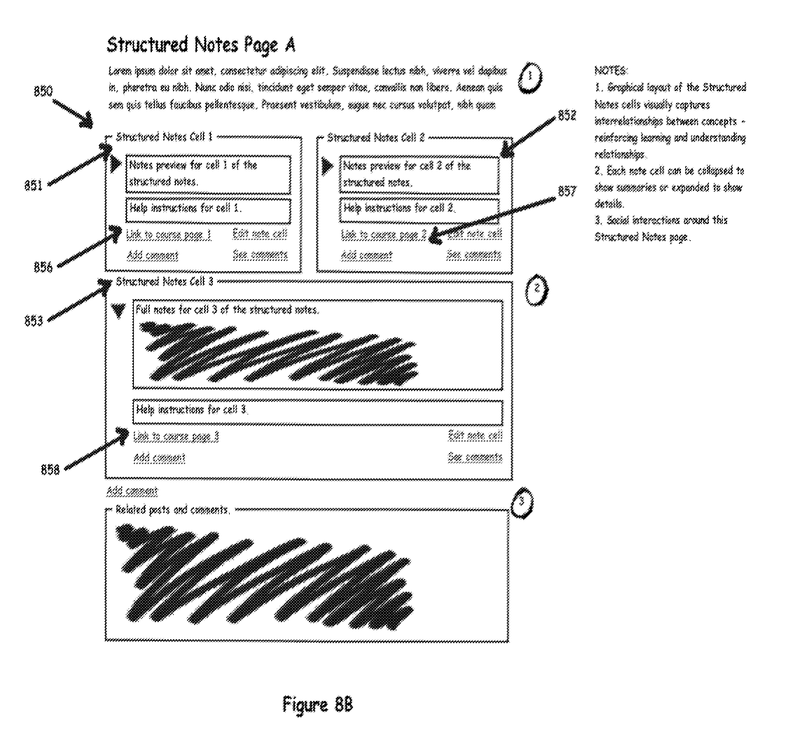

FIGS. 8A and 8B schematically illustrate embodiments of the Structured Notes Page aspect for a particular course. The Structured Notes aspect preferably consists of four separate content types—one for the structured notes template, one for the cells comprised in the template, one for user Structured Notes Page instances, and one for the filled-in structured notes cell contents. Custom code controls the binding between all four content types to provide formatted views of a Structured Notes Page with the cell contents in the appropriate locations. Implementation of the Structured Notes aspect is provided through structured notes module 280

As shown in FIG. 8A, a course page 331 preferably comprises an interactive form 801 for making entries into the Structured Notes cell 811 that is coupled with that course page 331. Preferably instructions for filling out a particular cell in a Structured Notes Page are included on a course page 331 together with an interactive form for filling out that cell.

Users will also be able to see their completed Structured Notes Pages (and works in progress) in a single view on their Structured Notes Dashboard page. This provides the benefit of being able to develop Structured Notes Page content as they go through specific instructions in the course, and then use the completed structured notes as reference materials, and also to edit the completed structured notes in a single place.

FIG. 8B schematically shows an overview 850, comprising an aggregated view of Structured Notes cells 851, 852, 853, allowing the user to quickly read these notes and jump to associated course pages. To this end each shown Structured Note 851, 852, 853 has a hyperlink 856, 857, 858 that is coupled to the respective associated course pages.

The structured notes module 280 further comprises code that enables students to create new blank structured notes pages, so that they can use the same structured notes design multiple times for multiple case study or real-world applications. For example they may generate multiple ‘customer’ structured notes pages in a sales course, one for each of their customers. In FIG. 10 this is shown as form area 1002. The dropdown box 1003 provides a list of the structured notes designs that course designers have defined for that course. Students enter the new Structured Notes Page Title and select one of these form designs, then click on the Create button 1004 to create a new, blank Structured Notes Page.

The structured notes module 280 further provides code to let course designers customize structured notes pages to specific course content. For example, in a sales training program, students might fill out a “customer profile structured notes” as they went through the course. The system supports the ability to fill out cells of the structured notes page as they go through the course, with their entries in each cell as they go through the course being aggregated up to an overview structured notes page they can view in one on place on their structured notes page.

FIG. 9 schematically shows an example of a Structured Notes Page as may be available from the links to structured notes pages shown in area 1001 of FIG. 10 in a particular course, as generated by the structured notes module 280 and rendered through the rendering module 225. In this schematic example the main title “Task Force Meeting Worksheet” represents the title of the Structured Notes instance (the title being assigned by the user when they created the Structured Notes instance). The titles “Context Framing”, “Issues”, “Outcomes” and “Option Generation” represent titles for cells in the Structured Notes Page (defined by the Course Designer). The text within the rectangles 910 under each cell title represents either instructions to the user as to how to fill out the cell (if they have not entered data) or the content they have entered into that cell (if they have made an entry). The “Page” link 912 under each cell title provides a link to the course page where instructions for how to fill out that Structured Notes cell are provided. The “Edit” link 913 under each cell title allows the user to create or edit their entry for that cell.

In an embodiment, users can comment on structured notes cells and entire structured notes pages, supporting social interactions around the structured notes. In this case, the user's Structured Notes page may include summaries of and/or references to those comment threads, similar to the functionality described above for the display of comment summaries on the User Dashboard. Implementation of this embodiment similarly follows the implementation of that functionality.

In a further embodiment, responses posted in structured notes pages as a user goes through a course may be automatically aggregated into larger structured notes that contain selected information from more than one individual structured notes page. For example, in developing a prospect profile during a sales course, a user may fill out structured notes about individual aspects of their prospect profile and then those results may be aggregated into an overview structured notes page for each prospect.

Each of these embodiments, and even more so when any number of these embodiments are combined, provides high user engagement around each specific learning topic, enhances the learning experience by offering direct interaction between users, as if they were in the same class together but without requiring physical and temporal co-location and with additional tools and resources, creates a valuable online learning community where users can learn from and contribute to each others' learning experience. Further, course designers may gain insight into how students are using the course by reviewing user posts—which supports continuous improvement of course content.

The above provides a description of several useful embodiments that serve to illustrate and describe the subject matter disclosed herein. The description is not intended to be an exhaustive description of all possible ways in which the subject matter can be implemented or used. The skilled person will be able to think of many modifications and variations that still rely on the essential features as presented in the claims. In addition, well-known methods, procedures, components, software design and development methodologies and circuits have not been described in detail.

The subject matter may be implemented in a computer program product, i.e., a collection of computer program instructions stored on a computer readable storage device for execution by a computer. The instructions may be in any interpretable or executable code mechanism, including but not limited to scripts, interpretable programs, dynamic link libraries (DLLs) or Java™ classes. The instructions can be provided as complete executable programs, as modifications to existing programs or extensions (“plugins”) for existing programs. Moreover, parts of the processing may be distributed over multiple computers or processors for better performance, reliability, and/or cost.

Storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. Transmission of the computer program product by e-mail is of course also possible. Embodiments may alternatively be deployed as an internet-based service, for example using a Software-as-a-Service (SaaS) model which allows executing the subject matter in a scalable computing platform.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the subject matter. Any reference to a claim feature in the singular shall not exclude the presence of a plurality of this feature. The word “means” in a claim can refer to a single means or to plural means for providing the indicated function.

1. A system for supporting electronic learning over a network for a plurality of students, comprising:
a course provision module operable for the plurality of students to access courseware in the form of one or more course pages individually accessible over the network,
a comment presenting module operable for inserting comments into a selected course pages, the comments having been previously posted by one or more of the plurality of students accessing the selected course page, the comment presenting module further operable to allow one or more of the plurality of students accessing the selected course page to view the posted comments,
a commenting module operable for allowing a particular one of the plurality of students to post one or more further comments for the selected course page, wherein the one or more further comments are inserted into the selected course page by the comment viewing module, and
a limiting module for allowing the particular one of the plurality of students to limit visibility of any particular comment posted by that particular student to one or more other selected students accessing the selected course page.

2. The system of claim 1, further comprising a module for dividing the plurality of students into members of student groups, such that each student is able to view only the posted comments by students who are within one or more student groups in which a given student is also within.

3. The system of claim 2, further comprising a module for allowing each member of a particular student group to limit visibility of any particular comment posted by that member to one or more selected members of that student group.

4. The system of claim 2, further comprising a module for a course administrator to restrict, on a course-page-by-course page basis, which of the student groups that a particular student is a member of will be available for the student to post comments to on the given course page.

5. The system of claim 1, wherein each student may be presented with any comments assigned to the student and in particular, presented regardless of whether such comments are related to the course page in which the comments are presented.

6. A system for supporting electronic learning over a network to plural students, comprising
course provision means for the plural students to access courseware in the form of one or more course pages individually accessible over the network,
comment presenting means for inserting comments into each course page, said comments having been previously posted by students accessing that course page, allowing students accessing that course page to view the posted comments as an integral part of the course page,
commenting means for allowing a particular of the plural students to post one or more further comments for that course page, which one or more further comments then are inserted into the course page by the comment viewing means, and
limiting means for allowing the particular student to limit visibility of any particular comment posted by that particular student to one or more of plural mentors who have been assigned to the particular student.

7. The system of claim 6, further comprising means for dividing the plural mentors into plural mentor groups, the limiting means being configured to limit visibility of any particular comment posted by that particular student to some or all of the plural mentor groups comprising at least one mentor who has been assigned to the particular student.

8. The system of claim 6, further comprising means for assigning the plural students to plural mentor groups, a given mentor being able to view only the posted comments by students being assigned to one or more mentor groups the given mentor is a member of.

9. The system of claim 8, further comprising means for allowing each student assigned to a particular mentor group to limit visibility of any particular comment posted by that student to one or more mentors within that mentor group instead of all mentors within that mentor group.

10. The system of claim 8, further comprising means for a course administrator to restrict, on a course-page-by-course page basis, which of the plural mentor groups that the particular student is assigned to of will be available for the student to post comments to on the given course page.

11. The system of claim 6, in which in addition to the posted comments, each mentor is presented with any comments assigned to him in particular, regardless of whether such comments are related to the course page as part of which they are presented.

12. The system of claim 6, further comprising means for allowing the particular student to limit visibility of any particular comment posted by that particular student to one or more selected mentors of a mentor group instead of all mentors of that mentor group.

13. A system for supporting electronic learning over a network to plural students, comprising
a course provision module operable for the plural students to access courseware in the form of one or more course pages individually accessible over the network,
a note taking module operable for enabling each of the plural students to record notes for a particular one of the one or more course pages and for associating the recorded notes with the particular course page for which the notes were recorded, and
a note accessing module operable for presenting a predetermined set of recorded notes for a particular student on a single overview page in a graphical overview in a structured fashion with predefined cells that each are to contain particular types of notes, each cell that actually contains a recorded note being configured with a hyperlink that enables access of a particular course page for which the recorded note was recorded.

14. The system of claim 13, in which the recorded notes as presented on the single overview page are editable.

15. The system of claim 14, in which any edits made to the recorded notes as presented on the single overview page are presented both on the single overview page and on the course page with which the note is associated.

16. The system of claim 13, wherein the note presenting module is further operable for inserting into each course page one or more of the recorded notes associated with that particular course page, allowing students accessing that course page to view the recorded notes as an integral part of the course page.

17. The system of claim 16, further comprising a commenting module operable for allowing a particular of the plural students to post one or more comments to a recorded note as inserted into the course page, which one or more further comments then are inserted into the course page by the note viewing module.

18. The system of claim 13, in which a course designer may define semantic relationships between recorded notes such that the system is configured to automatically generate a graphical layout of the graphical overview page.

19. A non-transitory computer-readable storage medium having computer-executable instruction, the instructions operable to:
provide access for plural students to courseware in the form of one or more course pages individually accessible over the network;
insert comments from one or more students into each course page, the comments having been previously posted by students that had accessed the course page;
allow students accessing the course page to view the posted comments as an integral part of the course page;
allow one of the plural students to post one or more further comments for the course page such that the one or more further comments are inserted into the course page; and
limit the visibility of any particular comment posted by a particular student to one or more other selected students accessing the course page.
